(19) United States
(12) Patent Application Publication
(10) Pub. No.: US 2006/0077463 A1
(43) Pub. Date: Apr. 13, 2006

(54) Image data output device and method for reordering and outputting data

(75) Inventors: Yoshiki Nakazawa, Toyokawa-shi (JP); Takahiro Doi, Toyokawa-shi (JP); Shiro Tsujioka, Toyokawa-shi (JP); Yasuhiro Ishihara, Toyokawa-shi (JP); Syuji Maruta, Toyokawa-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Konica Minolta Business Techologies, Inc., Tokyo (JP)

(21) Appl. No.: 11/019,052

(22) Filed: Dec. 22, 2004

(30) Foreign Application Priority Data
Oct. 7, 2004 (JP) 2004-294999

(51) Int. Cl. G06K 15/00

(52) U.S. Cl. 358/1.16

(57) ABSTRACT

Input data that is inputted in an image data output device includes information (file name, transmission origin, transmitter, file type, date of update, size and the like) indicating the attributes of this data. A setting file for setting the characteristics for data sorting in each of data sorting boxes is attached to each of these boxes. Data sorting is carried out on the basis of the setting file. A setting file for setting the characteristics of the reordering of the data in each of data reordering boxes is attached to each of these boxes. Data reordering is carried out on the basis of the setting file. The data that has been reordered is outputted (for example, printed) in the reordered order.

This application is based on Japanese Patent Application No. 2004-294999 filed with the Japan Patent Office on Oct. 7, 2004, the entire content of which is hereby incorporated by reference.

### BACKGROUND OF THE INVENTION

1. Field of the Invention

The present invention relates to an image data output device, an image data output method, and an image data output program, and, in particular, an image data output device, an image data output method, and an image data output program for reordering data on the basis of the order designated by the user, which is then outputted.

2. Description of the Related Art

As shown in Japanese Laid-Open Patent Publication No. 2000-082127, an image data output device has been proposed wherein the user sets information concerning the order of displaying image data and prepares a file, and wherein images are then sequentially displayed on the basis of this file.

The order and the conditions of outputs are set for such an image data output device, which outputs and prints on the basis of the contents of this setting, and therefore, desired types and definition of the data are not considered in the output, causing the problem of difficult usage.

### SUMMARY OF THE INVENTION

The present invention is provided in order to solve such a problem, and an object thereof is to provide an image data output device, an image data output method and an image data output program which are easy to use.

In order to achieve the above object, according to an aspect of this invention, an image data output device is provided with: a first data information acquirer for acquiring information concerning image data that has been inputted; a plurality of first memory regions for storing image data; a data memory controller for storing the image data in a corresponding memory region from among the plurality of first memory regions based on information that has been acquired by the first data information acquirer; a second data information acquirer for acquiring information concerning the image data that has been stored in the first memory regions by means of the data memory controller; a managing part for managing the order of the output of data that has been set in each of the first memory regions; a second memory region for storing the image data that has been stored in the first memory region in the order of the output that has been managed by the managing part on the basis of the information that has been acquired by the second data information acquirer; and an outputting part for outputting image data in accordance with the order that has been stored in the second memory region.

According to another aspect of this invention, an image data output device is provided with: a first data information acquirer for acquiring information concerning image data that has been inputted; a plurality of first memory regions for storing image data; a data memory controller for storing the image data in a corresponding memory region from among the plurality of first memory regions on the basis of information that has been acquired by the first data information acquirer; a second data information acquirer for acquiring information concerning the image data that has been stored in the first memory regions by the memory controller; a managing part for managing the order of the output of data that has been set to each of the first memory regions; a second memory region for storing image data identification information that identifies image data in the order of the output that is managed by the managing part on the basis of information that has been acquired by the second data information acquirer; and an outputting part for outputting image data in accordance with the order that has been stored in the second memory region.

According to the invention, in an image data output device, information is acquired concerning image data that has been inputted; based on this information, the image data is stored in a corresponding memory region from among a plurality of first memory regions; information is acquired concerning the image data that has been stored in the first memory region; the order of the output of data that has been set to each of the first memory regions is managed; and the image data that has been stored in the first memory regions can be outputted in the order of the output that has been managed, and therefore, it becomes possible to provide an image data output device that is easy to use.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing the configuration of an image data output system according to an embodiment of the present invention;

FIG. 2 is a block diagram showing the configuration of MFPs 100a to 100c of FIG. 1;

FIG. 3 is a block diagram showing the configuration of one PC 200a or 200b of FIG. 1;

FIG. 4 is a block diagram showing a function configuration of MFP 3 (MFP 100c) shown in FIG. 1;

FIG. 5 is a block diagram showing the details of memory 104 of FIGS. 2 and 4;

FIG. 6 is a diagram showing an example of the operation of memory 104 of FIGS. 2 and 4;

FIG. 7 is a plan view of operation panel 105 of an MFP;

FIGS. 8 and 9 are diagrams showing the contents of displays on display 105a of operation panel 105, and the contents of displays in the case where box printing is indicated;

FIGS. 10 and 11 are diagrams showing the contents of displays on display 105a in the case where data that has been read from scanner 101 is registered in a box;

FIGS. 12 to 17 are diagrams showing the contents of displays on display 105a in the case where settings of boxes are carried out;

FIG. 18 is a diagram showing the contents stored by an MFP;

FIG. 19 is a diagram showing an image displayed on PC 200a or 200b;

FIG. 20 is a flowchart showing the entire flow of the process carried out in MFP 3;

FIG. 21 is a flowchart showing the content of the box managing process (S103) of FIG. 20;

FIG. 22 is a flowchart showing the contents of a data information acquiring, sorting and storing process (S211) of FIG. 21;

FIG. 23 is a flowchart showing the contents of the input data information setting (S303) of FIG. 22;

FIG. 24 is a flowchart showing the contents of the data information acquiring, reordering and storage process (S213) of FIG. 21;

FIG. 25 is a flowchart showing the contents of the print data output process (S105) of FIG. 20;

FIG. 26 is a flowchart showing the contents of the box printing process (S405) of FIG. 25;

FIGS. 27 and 28 are flowcharts showing modifications of the box printing process of FIG. 26;

FIG. 29 is a flowchart showing a modification of the data information acquiring, reordering and storage process of FIG. 24;

FIG. 30 is a flowchart showing the process at the time of the box printout (S405 of FIG. 25);

FIG. 31 is a diagram illustrating the operation of data reordering box 11;

FIG. 32 is a flowchart showing the process of data reordering;

FIG. 33 is a flowchart showing a modification of the flowchart of FIG. 20; and

FIG. 34 is a flowchart showing the contents of the box output time managing process (S102) of FIG. 33.

### DESCRIPTION OF THE PREFERRED EMBODIMENTS

An image data output system according to an embodiment of the present invention is described in the following.

The present system sorts and stores data that has been inputted in accordance with a preset data definition, and reorders this stored data in the order of a preset condition. Designated data can be collectively outputted by carrying out such a process without designation of the place where the data is to be stored or without tasks for adding or updating data carried out by the user.

In order to carry out such an operation, the image data output system is provided with an image data output device, and the image data output device has a function of acquiring, sorting and storing information data has been inputted, and a function of acquiring information concerning the order of the output, of managing the order of the output and of storing data that has been reordered. As a result of this, the image data output device sorts and stores data that has been inputted, and reorders and outputs data that has been stored.

In the configuration of the present embodiment, only desired data from among data that has been inputted at an arbitrary time is sorted and stored, and in addition, the stored data is reordered, and therefore, it becomes possible to reorder and output data in the newest condition, even after data has been added or updated.

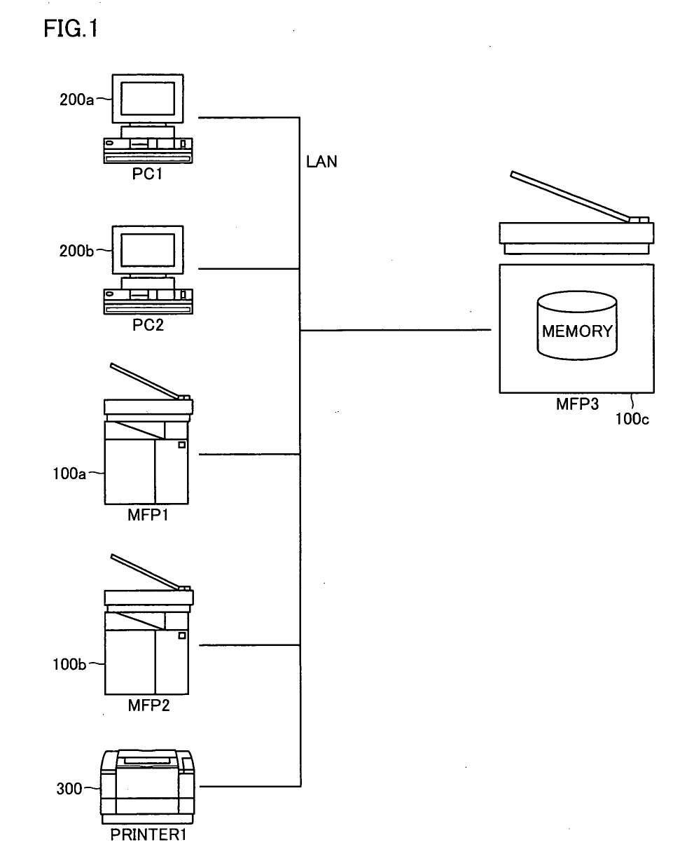

Referring to FIG. 1, in the image data output system, an MFP (Multi-Function Peripheral) 100c (also referred to as “MFP 3”) which is an example of an image data output device is connected to PCs (Personal Computers) 200a and 200b, a scanner, other MFPs 100a and 100b (respectively referred to as “MFP 1” and “MFP 2”), as well as a printer 300, by means of a network.

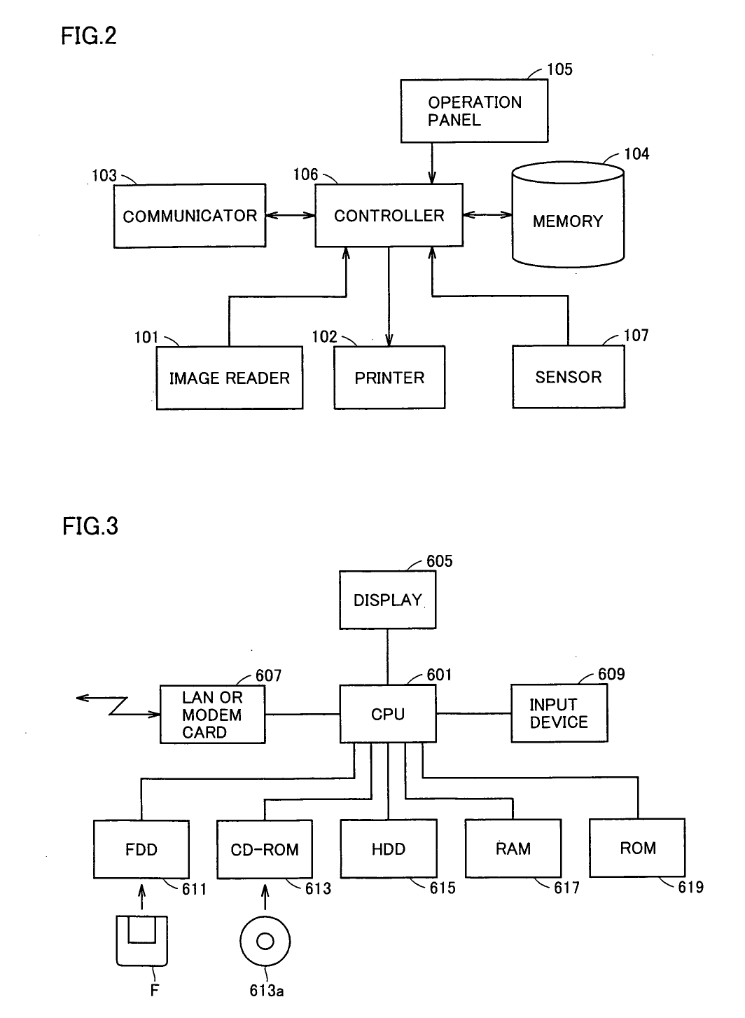

FIG. 2 is a block diagram showing the configuration of MFPs 100a to 100c of FIG. 1.

Referring to FIG. 2, each of MFPs 100a to 100c includes a controller 106 for controlling the entirety of the device, an image reader 101 for reading image data from a manuscript, a printer 102 for printing an image on a sheet of paper, a communicator 103 for carrying out wireless communication over a small distance or for connecting an MFP to a network or to a telephone line, a memory 104 for storing job data or the like, an operation panel 105 which is a user interface, and a sensor 107 for detecting the remaining amount of consumables or the like.

Here, printer 300 of FIG. 1 is shown after image reader 101 has been removed from the configuration of FIG. 2.

FIG. 3 is a block diagram showing the configuration of one PC 200a or 200b of FIG. 1.

Referring to FIG. 3, the PC is provided with a CPU 601 for controlling the entirety of the device, a display 605, a LAN (Local Area Network) card 607 (or a modem card) for the connection to a network or for communicating with the outside, an input device 609 formed of a keyboard, a mouse or the like, a flexible disk drive 611, a CD-ROM drive 613, a hard disk drive 615, a RAM 617, and a ROM 619.

Flexible disk drive 611 makes it possible to read out data such as a program that has been recorded in a flexible disk F, and CD-ROM drive 613 makes it possible to read out data such as a program that has been recorded in a CD-ROM 613a.

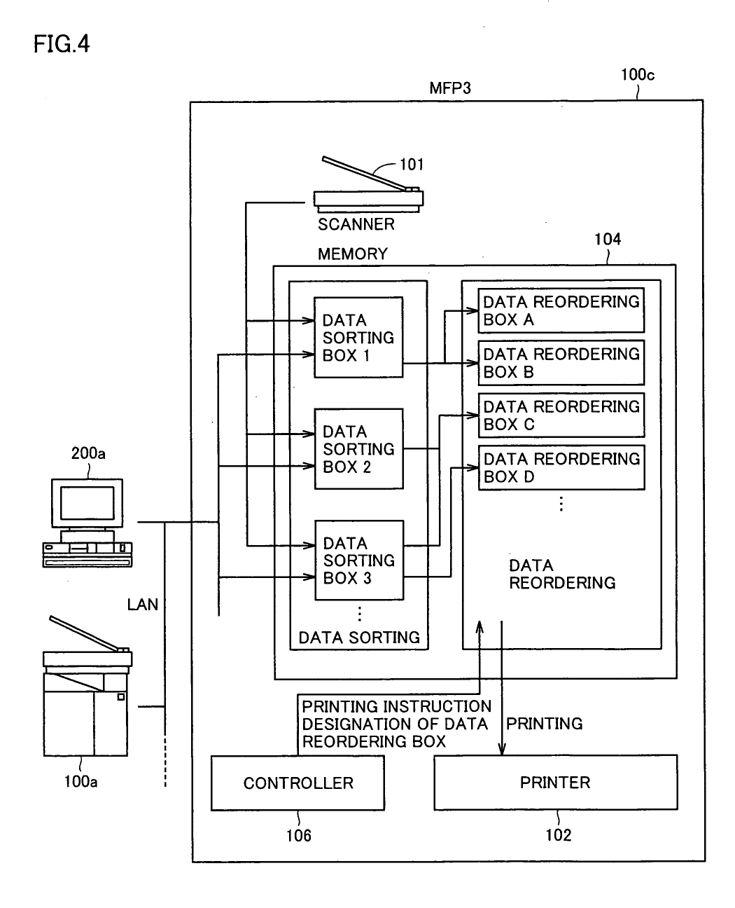

FIG. 4 is a block diagram showing a functional configuration of MFP 3 (MFP 100c) shown in FIG. 1.

Referring to FIG. 4, MFP 3 is provided with a scanner (image reader) 101 for reading out an image, a memory 104 for storing a variety of data and control programs, a printer 102 for printing, and a controller 106 for carrying out a process in accordance with the respective control programs.

Memory 104 is provided with a plurality of data sorting boxes (1, 2, 3, . . . ) for sorting and storing data including image data that has been transmitted from the scanner, the PC or another MFP on the basis of information (attributes) of this data and a plurality of data reordering boxes (A, B, C, D, . . . ) for reordering and storing the sorted data.

Controller 106 outputs data printing indication that has been stored in memory 104 on the basis of an indication from the user or the like, and printer 102 prints out data on the basis of this indication. In addition, at the time of printing, controller 106 designates a data reordering box that has stored the data that is printed out on the basis of the designation by the user.

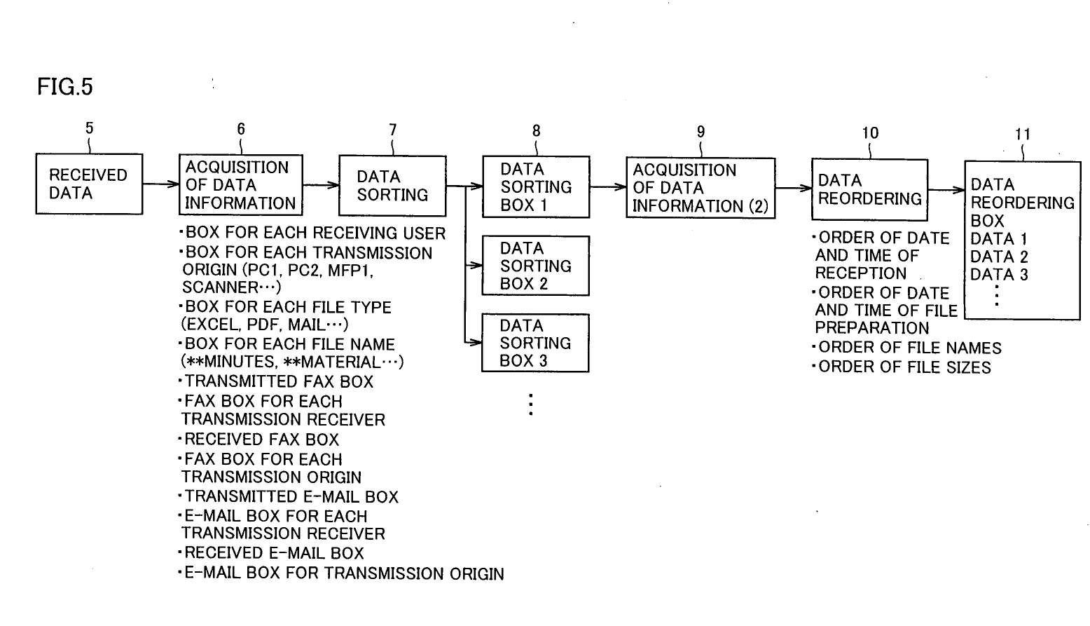

FIG. 5 is a block diagram showing the details of memory 104 of FIGS. 2 and 4.

In FIG. 5, memory 104 is provided with: a data information acquirer 6 for acquiring information, in order to sort data 5 received by MFP 3 (or data gained by means of scanner 101) in accordance with each definition that has been preset from this data; a data sorter 7 for sorting data in accordance with the acquired information; a data sorting box part 8 (a plurality of data sorting boxes (1, 2, 3, . . . )) for storing the sorted data in accordance with the respective definitions; a data information acquirer (2) 9 for acquiring information of the data that has been sorted and stored within a data sorting box; a data reordering part 10 for reordering data in such a manner that data is outputted under conditions that have been preset in accordance with the information acquired by data information acquirer (2) 9; and a data reordering box part 11 (a plurality of data reordering boxes (A, B, C, D, . . . )) for storing the data that has been reordered by data reordering part 10.

Data information acquirer 6 acquires the following information from each piece of data (such as data files), and data sorter 7 sorts the data on the basis of this information.

Receiver user

Transmission origin (PC1, PC2, MFP 1, SCANNER, . . . )

File type (excel, pdf, mail, . . . )

File name (**minutes, **material, . . . )

Transmitted FAX

Transmission receiver FAX

Received FAX

Transmission origin FAX

Transmitted E-mail

E-mail for each transmission receiver

Received E-mail

E-mail for each transmission origin

It is assumed that the following boxes are set as data sorting boxes which sort data on the basis of such information.

BOX for each of individual receiver users

BOX for each transmission origin (PC1, PC2, MFP 1, SCANNER, . . . )

BOX for each file type (excel, pdf, mail, . . . )

BOX for each file name (**minutes, **material, . . . )

BOX for transmission FAX

BOX for a FAX for each transmission receiver

BOX for received FAX

BOX for transmitted E-mail

BOX for E-mail for each transmission receiver

BOX for received E-mail

BOX for E-mail for each transmission origin

In addition, data reordering part 10 acquires such information as reception date and time, date and time of file preparation, file name and file size from each piece of data (such as data files), and reorders the data in the following order on the basis of this information.

Order of date and time of reception

Order of date and time of file preparation

Order of file names

Order of file sizes

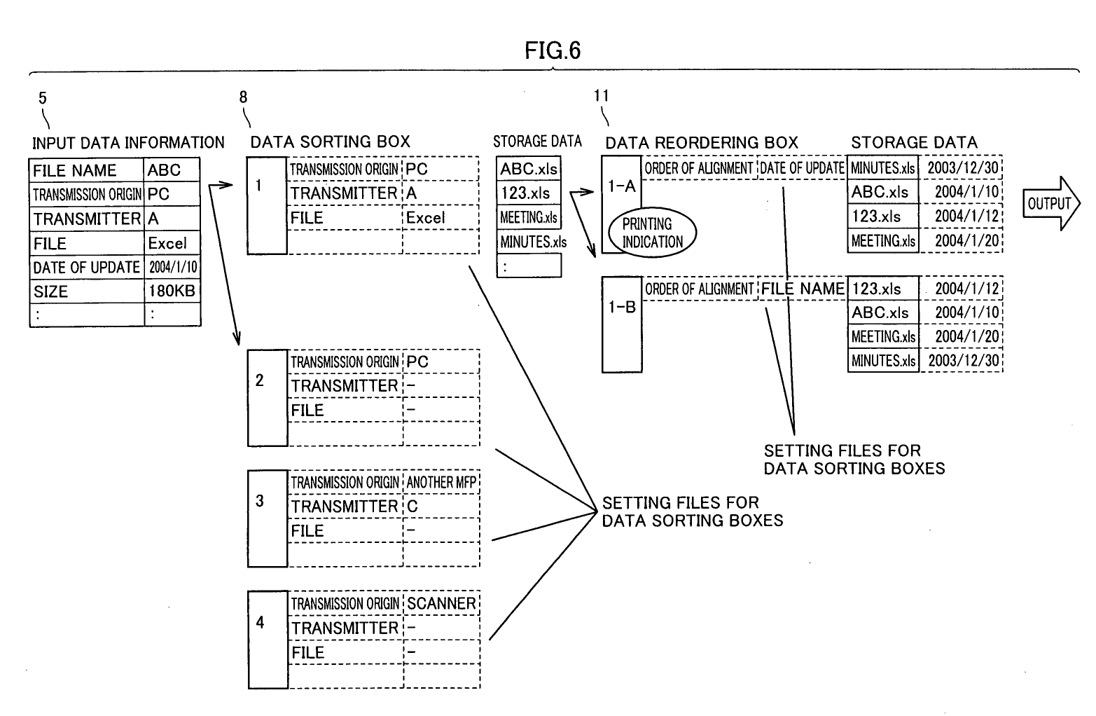

FIG. 6 is a diagram showing an example of the operation of memory 104 of FIGS. 2 and 4.

Input data 5 includes information (file name, transmission origin, transmitter, file type, date of update, size and the like) indicating attributes of the data.

A setting file for setting the characteristics of data sorting in each of data sorting boxes 8 is attached to the box. Sorting is carried out on the basis of this setting file.

Data sorting box 1 of FIG. 6, for example, is a box that stores a file having the transmission origin “PC,” the transmitter “A” and the file type “Excel.”

A setting file for setting the characteristics of reordering of the data in each of data reordering boxes 11 is attached to the box. Reordering is carried out on the basis of this setting file.

Data reordering box 1-A of FIG. 6, for example, is a box for reordering the data in data sorting box 1 in the order of date of update, and data reordering box 1-B is a box for reordering the data in data sorting box 1 in the order of file names.

The data that has been reordered in such a manner is outputted (printed out or the like).

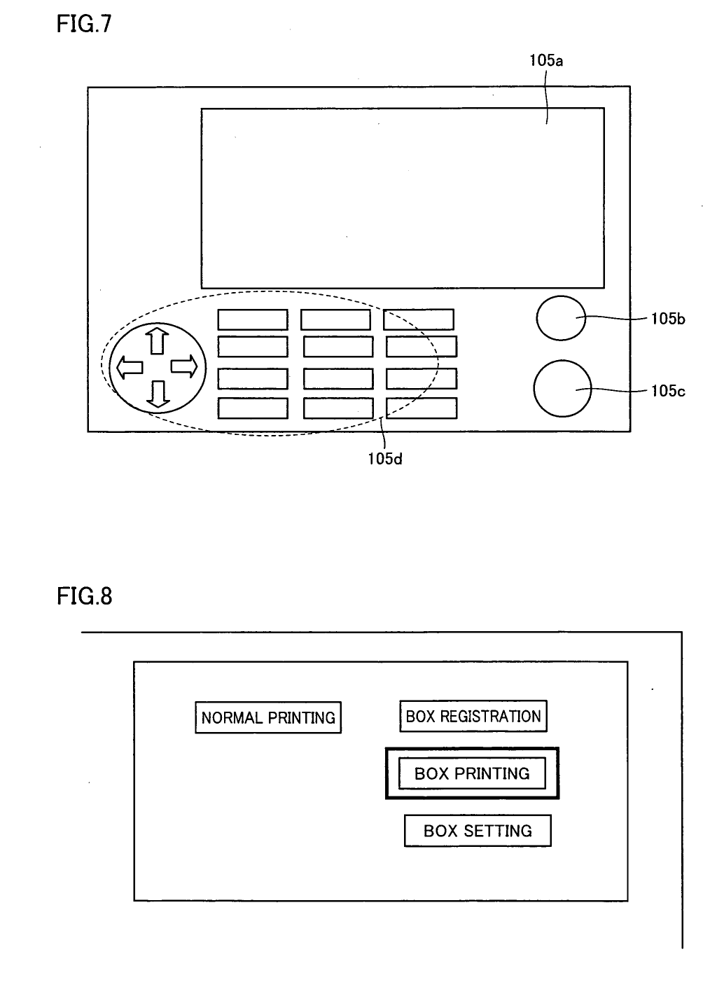

FIG. 7 is a plan view of operation panel 105 of an MFP.

Referring to FIG. 7, operation panel 105 is provided with a display (panel) 105a formed of a liquid crystal display device, a touch panel or the like, a stop button 105b, a start button 105c and operation buttons 105d including alphabetic and numeral keys or the like.

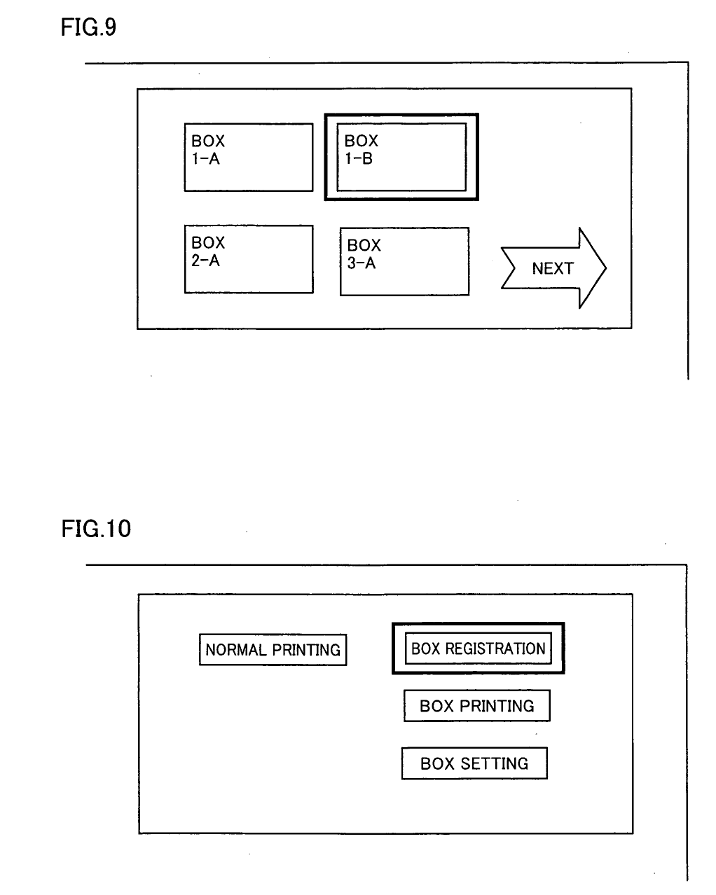

FIGS. 8 and 9 are diagrams showing the display contents of display 105a of operation panel 105, and showing the display contents in the case where box printing is indicated.

When the user desires to print out data stored in a desired box, the user selects “BOX print” in the panel at the time of the MFP standby condition of FIG. 8, and presses down START button 105c.

Then the screen of the panel changes to the box selection screen of FIG. 9. Thus, the user selects a desired box and presses down START button 105c, and thereby, printing of the data that has been stored in this box is started.

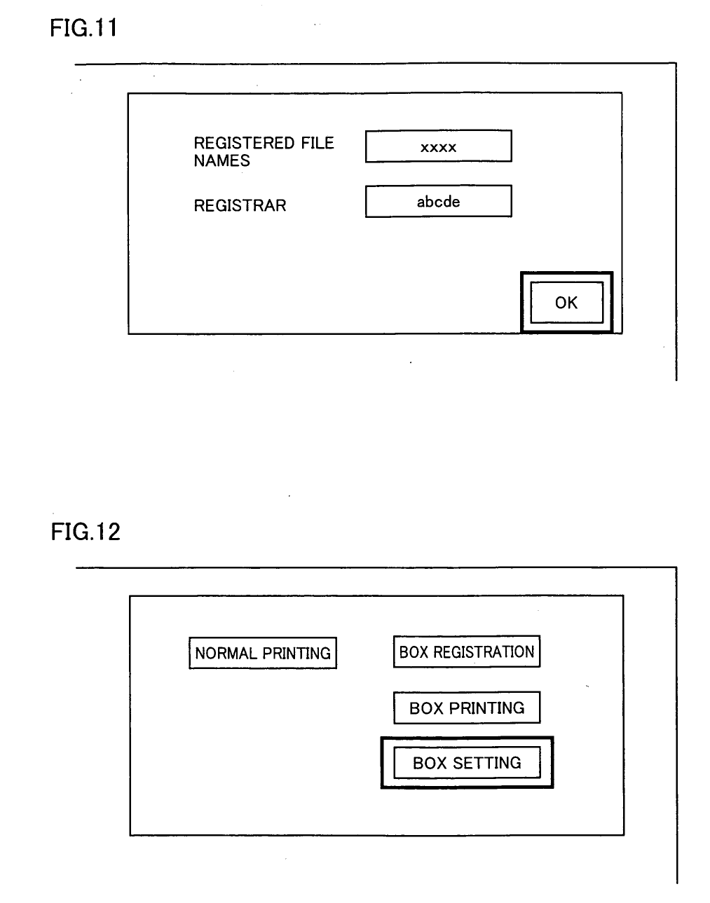

FIGS. 10 and 11 are diagrams showing the display contents of display 105a in the case where the data that has been read in from scanner 101 is registered in a box.

When the user selects “box registration” from the panel at the time of the MFP standby condition and presses down START button 105c, the screen of FIG. 11 is displayed. The user inputs necessary information (such as registered file name and registrar) from this screen, and then selects “OK” before pressing down START button 105c. As a result of this, scanning begins and the data information is added to the scanned data so that this data is stored in the box having matching conditions.

FIGS. 12 to 17 are diagrams showing the display contents of display 105a in the case where setting of a box is carried out.

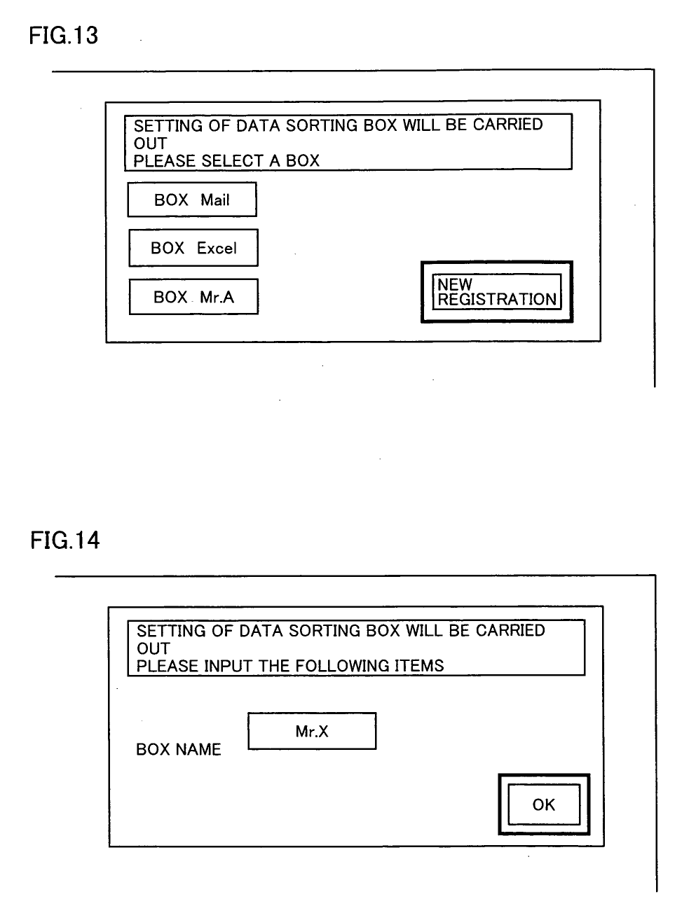

When “box setting” is selected from the screen (FIG. 12) in the standby condition of an MFP by the user, the screen of FIG. 13 is displayed.

Here, in the case where a box for sorting data is newly prepared, the user selects “new registration”. In the case where setting of an existing sorting box or setting of a data reordering box that corresponds to this is carried out, the user selects a desired box from among the displayed existing boxes.

In the case where “new registration” is selected, the screen of FIG. 14 is displayed. The user inputs an arbitrary box name from this screen.

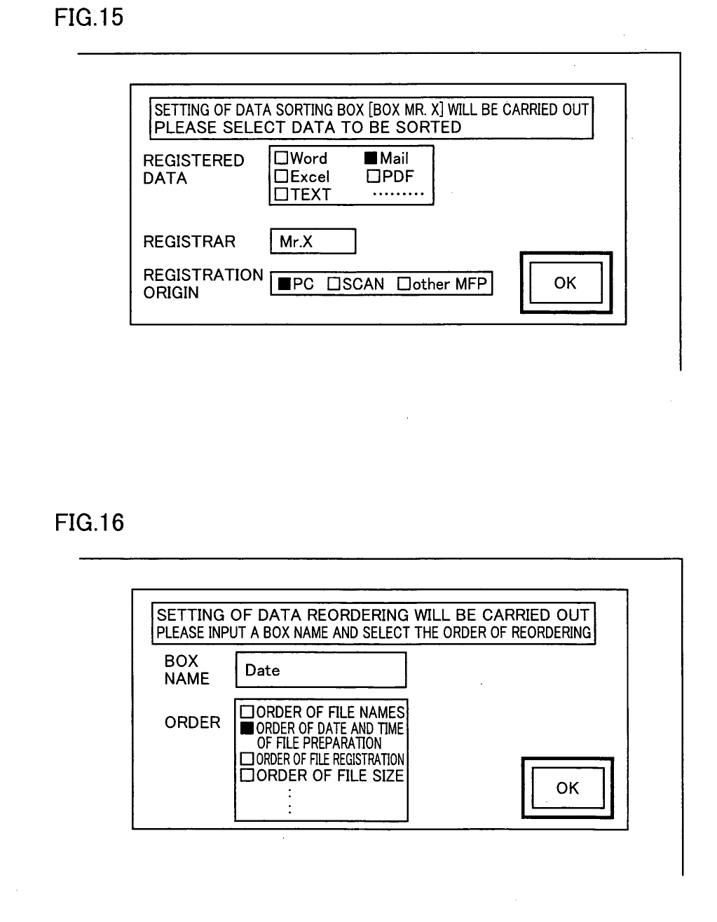

The screen of FIG. 15 is displayed when an existing sorting box has been selected or when a sorting box has been determined after the completion of a new registration.

The type of data that is to be sorted and sorted in this box is set on the screen of FIG. 15. In this embodiment, as shown in FIG. 15, the type, the registrar and the registration origin of the registered data are set.

After that, the screen of FIG. 16 is displayed and the order of the reordered data is set in the data reordering box that corresponds to the selected box. At this time, the user inputs an arbitrary box name. In addition, setting is carried out in such a manner that the order of the reordered files is set as the order of file names, the order of date and time of file preparation, the order of file registration or the order of file sizes.

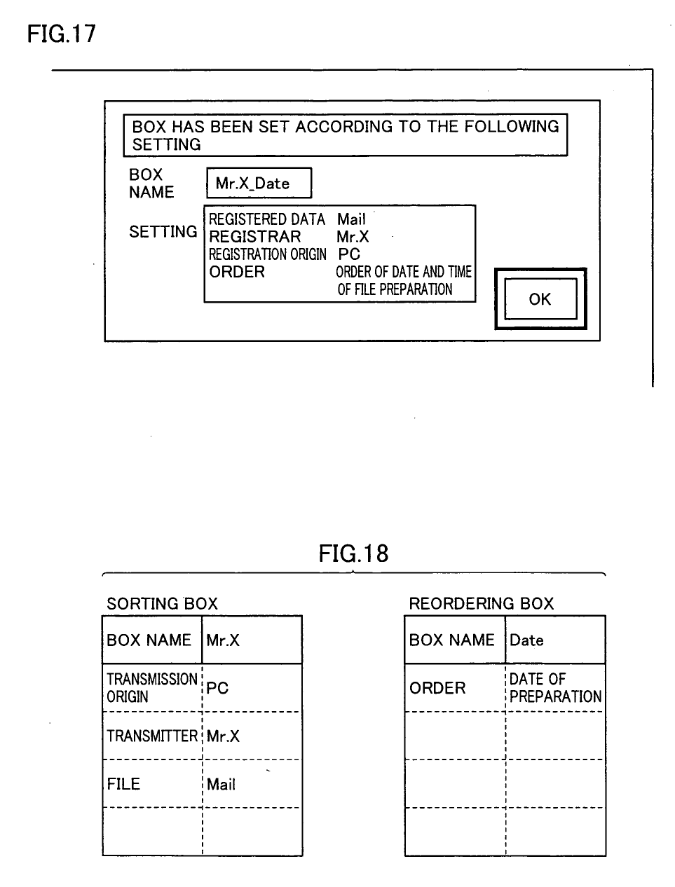

When the user operation in FIGS. 12 to 16 is completed, the contents that have been set are displayed, such as the screen of FIG. 17.

Here, “sorting box name_reordering box name” is added as a box name.

This setting is stored in the MFP, as shown in FIG. 18. That is to say, names of sorting boxes, registration conditions, names of reordering boxes and the order of reordering are made to correspond to each other and are recorded.

This setting is used as a setting file of FIG. 6, and the contents of this file and information of the inputted data are compared so as to provide a definition for storage in each box.

It is possible to register data from outside PCs 200a and 200b in each box.

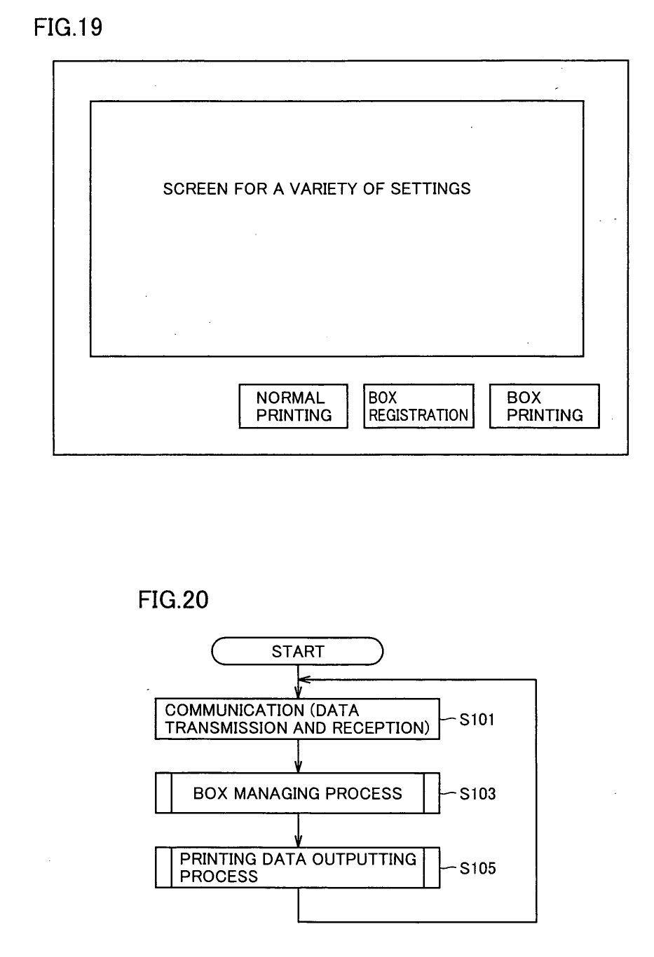

FIG. 19 is a diagram showing the screen displayed on PC 200a or 200b.

Referring to FIG. 19, registration of data from a PC in a box and printing out of data within the box are instructed through input by the user from the screen illustrated in FIG. 19. The user selects, for example, a desired instruction from among box registration, box printing and normal printing.

The MFP carries out the following operation on the basis of this instruction.

Normal printing: a designated file is printed out in a normal manner.

Box registration: the designated file is stored in a box having a matched condition.

Box printing: such a screen as that in FIG. 9 is displayed on a PC, and the data within box that has been selected from there is printed out.

FIG. 20 is a flowchart showing the entire flow of the process that is carried out by MFP 3.

In step S101, the MFP communicates with a PC or another server so as to receive data. In addition, data is inputted from scanner 101. In step S103, the box is managed in accordance with the contents of the data, and printing is carried out in step S105.

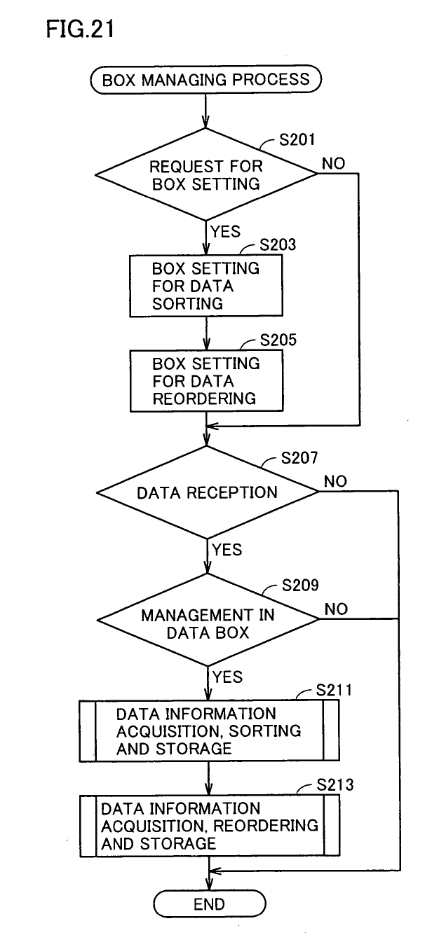

FIG. 21 is a flowchart showing the contents of the box managing process (S103) of FIG. 20.

The MFP carries out setting of the data sorting box and the data reordering box (S203 and S205) in the case where setting is requested to the box (YES in S201).

It is assumed that the data sorting box herein presets the following:

BOX for each transmission origin (PC1, PC2, MFP 1, SCANNER, . . . )

BOX for each of individual receiver users

BOX for each file type (excel, pdf, mail, . . . )

BOX for each file name (**minutes, **material . . . )

BOX for transmitted FAX

BOX for FAX for each transmission receiver

BOX for received FAX

BOX for FAX for each reception origin

BOX for transmitted E-mail

BOX for E-mail for each transmission receiver

BOX for received E-mail

BOX for E-mail for each transmission origin

In the present embodiment, the setting items in the data sorting box are the transmission origin, the transmitter and the data (file) type (see the left side of FIG. 18).

Here, the following boxes are preset as data reordering boxes:

Order of date and time of reception

Order of date and time of file preparation

Order of date and time of file update

Order of file names

Order of file sizes

Order of creators

Upon the reception of data (YES in S207), the MFP acquires information that has been set in the preset data sorting box and data reordering box, and determines whether or not data boxes are managed (S209). In the case where the information is managed, the information set in the boxes are compared with the attributes of data, and thereby, the received data is sorted into data sorting boxes (S211), and the data that has been reordered in the data reordering box is stored (S213).

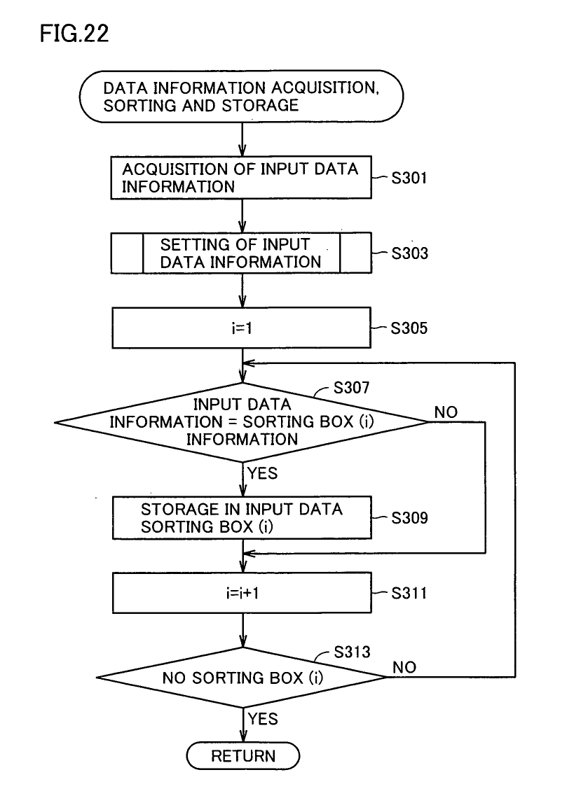

FIG. 22 is a flowchart showing the contents of the data information acquisition, sorting and storage process (S211) of FIG. 21.

In this flowchart, first, the information of the inputted data is acquired (S301). The acquired information is the same type of information as the information which is set for the sorting of data into the data sorting boxes. In the present embodiment, information concerning transmission origin, transmitter and data (file) type is acquired. Information of the input data is set on the basis of the information of the acquired data (S303). In addition, information such as date of file preparation, date of update, file name, size and the like, which determines the reordering condition, is also acquired.

Number “i” is added to each of the plurality of sorting boxes (i is an integer), and information of input data and information that is set for each sorting box are compared sequentially starting from the sorting box i=1 (S305). When the information agrees (YES in S307), the data is stored in this sorting box (S309).

Such a comparison and storage process is carried out for all of the boxes (S311 and S313). When the information agrees, the same data is copied so as to be stored in the plurality of boxes.

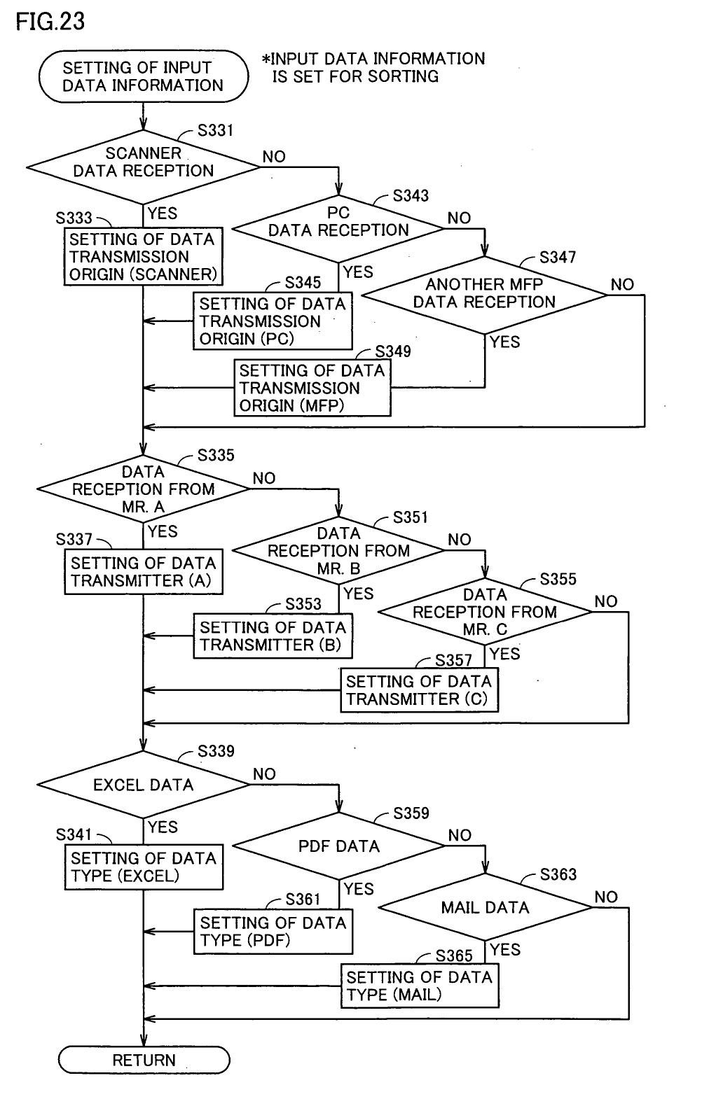

FIG. 23 is a flowchart showing the contents of input data information setting (S303) of FIG. 22.

Here, whether the transmission origin of the input data is a scanner (S331), a PC on the network (S343) or another MFP on the network (S347) is determined in order to sort the data into data sorting boxes, and the determination result is set (S333, S345 and S349).

In addition, whether the data transmitter is Mr. A (S335), Mr. B (S351) or Mr. C (S355) is determined, and the determination result is set (S337, S353 and S357).

Furthermore, whether the file type is Excel (S339), PDF (S359) or mail (S363) is determined, and the determination result is set (S341, S361 and S365).

Here, in the process of determination in each branch in FIG. 23, the process that corresponds to the information set in each data sorting box (storage condition) is carried out.

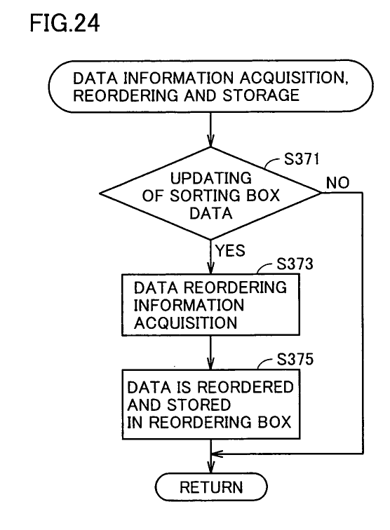

FIG. 24 is a flowchart showing the contents of the data information acquisition, reordering and storage process (S213) of FIG. 21.

In the case where the received data is stored in a data sorting box and the data sorting box is updated (YES in S371), information for reordering that has been set in the data reordering box is acquired (S373), and the data is reordered and stored in the data reordering box (S375).

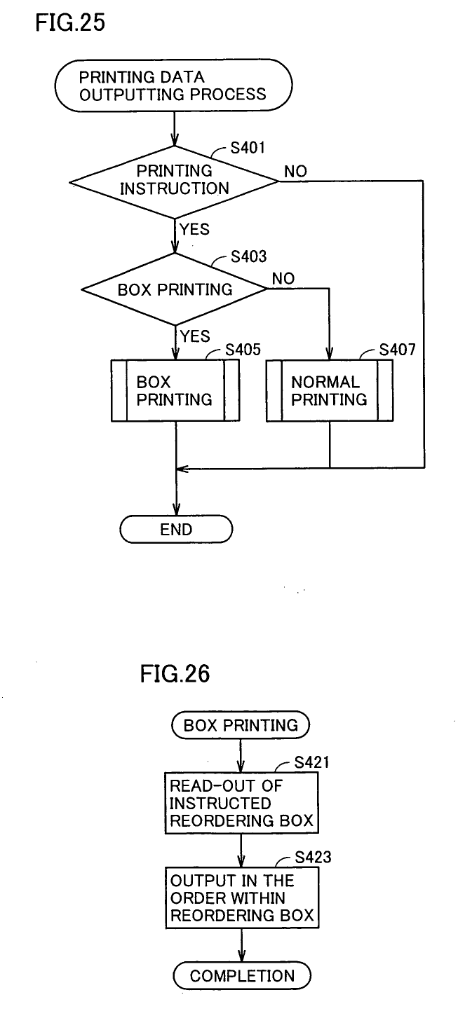

FIG. 25 is a flowchart showing the contents of the data output printing process (S105) of FIG. 20.

Here, in the case of no printing indication (NO in S401), the process is completed. In the case of a printing indication (YES in S401), printing is carried out. At this time, in the case of a box printing indication (YES in S403), printing of data within the designated box is carried out (S405), while in the case of no box printing indication (NO in S403), the received data is printed out as it is (S407).

FIG. 26 is a flowchart showing the contents of the box printing process (S405) of FIG. 25.

When the data reordering box that is to be printed is designated by the user (S421) and a printing indication is received, the data that has been stored in the designated data reordering box is read out (S421). The data within the data reordering box is aligned in the order of output, and therefore, outputting and printing are carried out in this order (S423).

First Modification

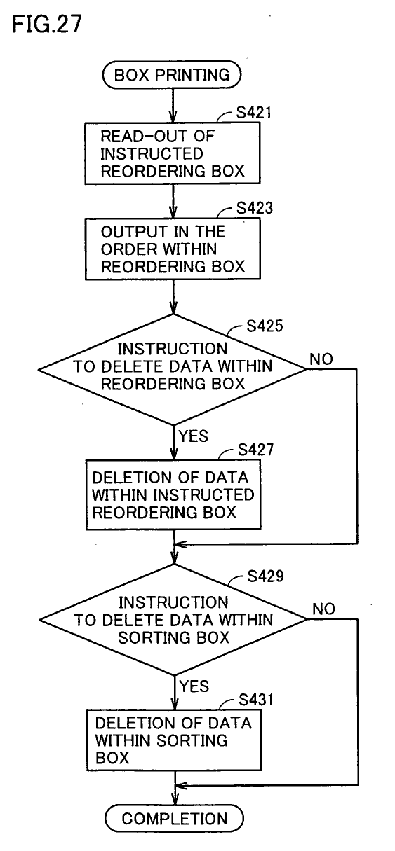

FIG. 27 is a flowchart showing a modification of the box printing process of FIG. 26.

This flowchart is characterized in that designated data is deleted after printing has been carried out. As a result of this, unnecessary data can be prevented from being left within the box.

When a data reordering box that is to be printed is designated and a printing indication is received, data within the designated data reordering box is read out (S421).

The data within the data reordering box is aligned in the order of output, and therefore, output and printing are carried out in this order (S423).

In the case where the operation of deleting data within the data reordering box that has been outputted and printed is selected (YES in S425, and this selection is on the basis of the user setting), the data within the data reordering box where the output and printing have been completed is deleted (S427). In the same manner, in the case where the operation of deleting the data within the data sorting box that has been outputted and printed is selected (YES in S429, and this selection is based on the user setting or the like), the data within the data sorting box where the output and printing have been completed is deleted (S431).

As described above, in the present modification, when the operation of deleting data within a box has been selected by the user, the data within the box is deleted after output.

Second Modification

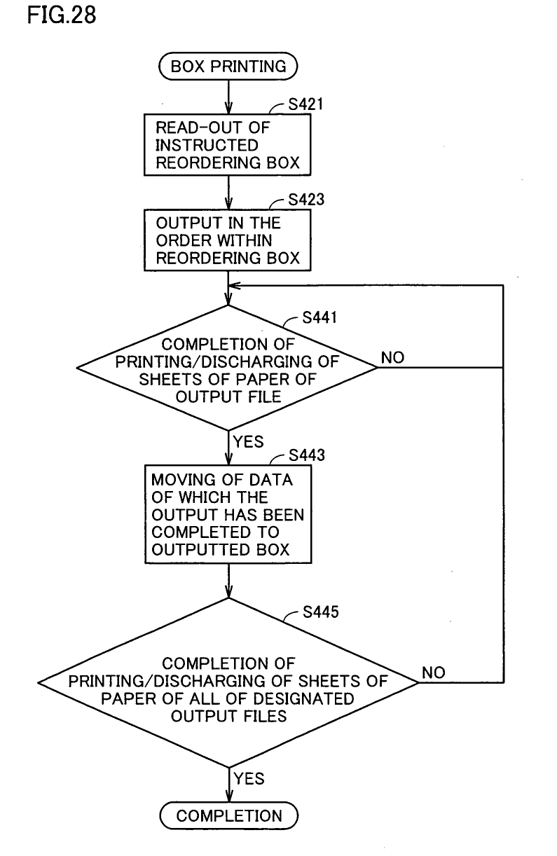

FIG. 28 is a flowchart showing a modification of the box printing process of FIG. 26.

In this flowchart, after printing has been carried out, the designated data is moved to the output process completing box (which is also referred to as output completion box).

In the same manner as the process of FIG. 26, the data within the box where there has been a printing indication is outputted in accordance with the alignment order (S421 and S423).

When printing/discharge of a sheet of paper of the designated output data has been completed (YES in S441), this data is moved to the output completion box (S443).

When printing/discharge of a sheet of paper of the entire data that has been indicated for output has been completed (YES in S445), the process is completed.

Third Modification

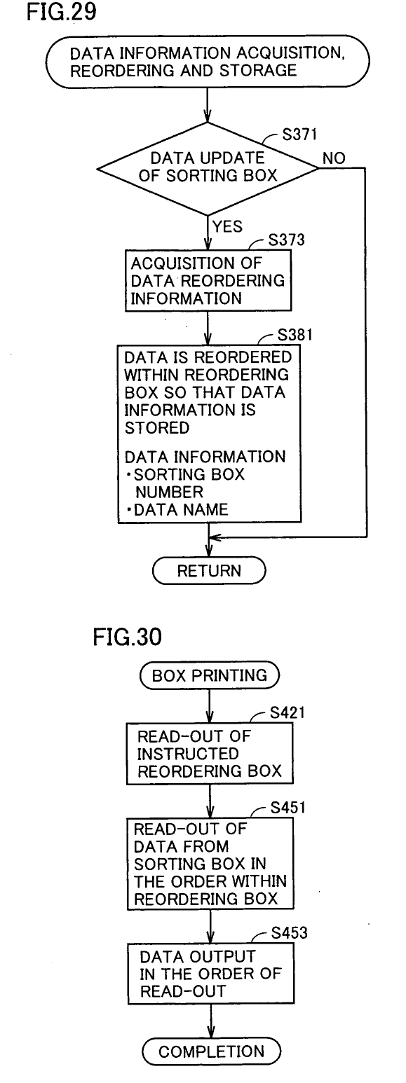

FIG. 29 is a flowchart showing a modification of the data information acquiring, reordering and storage process of FIG. 24.

In this modification, data that is stored in a reordering box is not data itself, but rather, is information concerning this data.

In the same manner as in FIG. 24, when the data within the sorting box is updated in the present routine (YES in S371), information for data reordering is acquired (S373) and data reordering is carried out (S381). Here, the data that is stored in the reordering box is not data itself, but rather, is a box name where the data is stored or a data name itself.

At the time of the box printing output (S405 in FIG. 25), information recorded in a reordering box where there is a printing indication is sequentially read out (S421), as shown in the flowchart of FIG. 30, and the data is read out (S451) from the sorting box in this sequence so as to be outputted in sequence (S453).

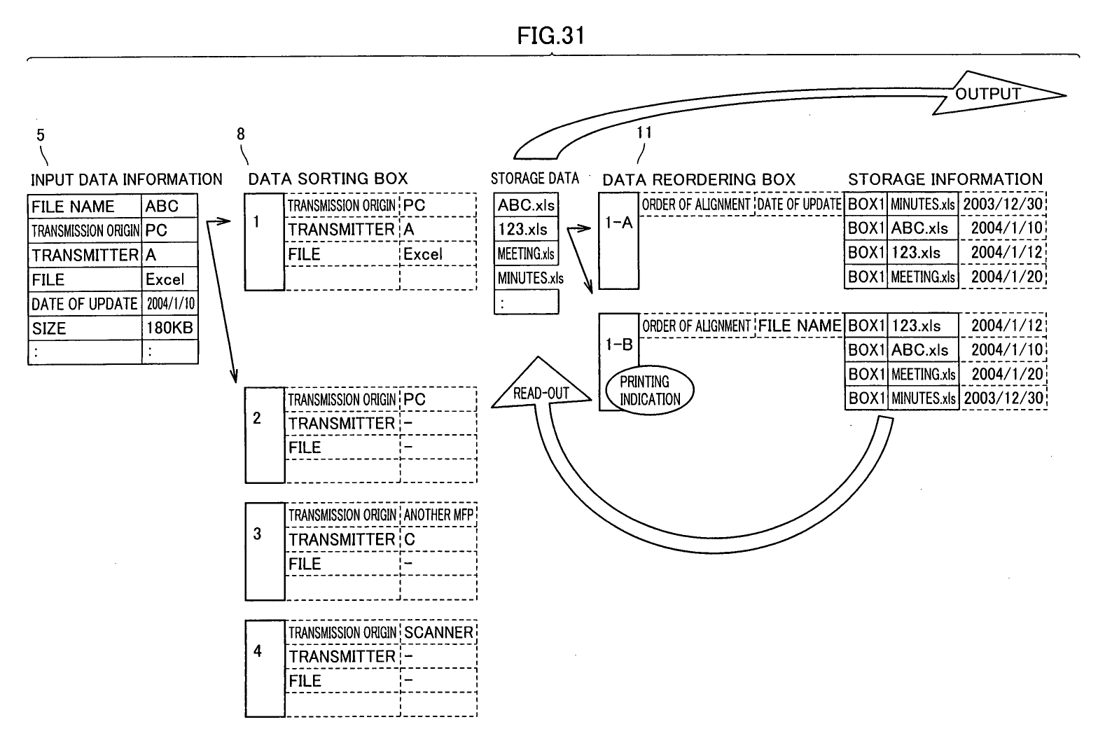

That is to say, as shown in FIG. 31, data is not stored in a data reordering box 11 as shown in FIG. 6, but rather, the title of the data sorting box where the data exists and the data name are stored in data reordering box 11. The corresponding data within data sorting box 8 is read out in the order of storage information recorded within the data reordering box so that this data is outputted.

Fourth Modification

In the embodiments, data within a data sorting box is updated whenever an MFP receives or modifies the data. When the data within the data sorting box is updated, the data within the data reordering box is also updated. When the data reordering box is designated at the time of printing, the MFP carries out printing of data in the order where the data has already been reordered within the data reordering box.

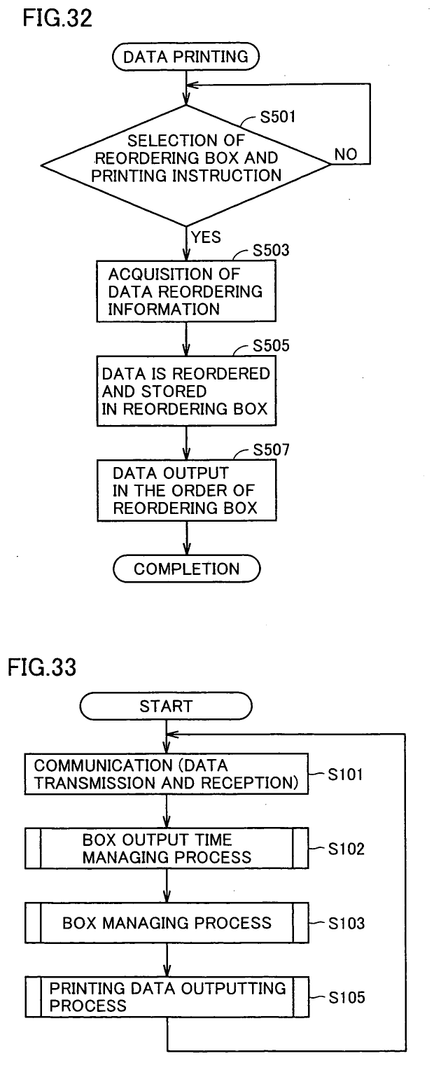

In the present modification, as shown in the flowchart of FIG. 32, the data within the data sorting box is acquired and reordered at the time when the data within the data reordering box is printed.

That is to say, at the time when a reordering box is selected and printing is instructed (YES in S501), information for reordering data is acquired (S503). Then, data is reordered and stored in the reordering box (S505).

After that, the data is outputted in the order of the data that has been stored in the reordering box (S507).

Fifth Modification

FIG. 33 is a flowchart showing a modification of the flowchart of FIG. 20.

In the present flowchart, different from the flowchart of FIG. 20, time is managed and printing of data within a box is automatically started at a certain time, even without a printing indication from another device.

That is to say, in addition to the process of FIG. 20, a box output time management process is carried out in step S102.

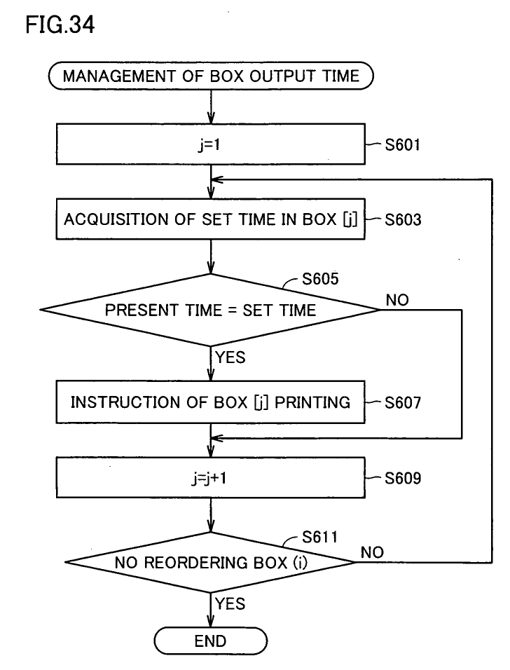

FIG. 34 is a flowchart showing the contents of a box output time management process (S102) of FIG. 33.

Here, the following processes are carried out (S601, S609 and S611) on all of the reordering boxes (and/or sorting boxes). First, time that has been preset in each box is acquired (S603). The present time and the set time are compared (S605), and in the case where they are the same, a print output instruction of data within the box is issued (S607). As a result of this, data can be automatically outputted at a predetermined time.

Here, programs for carrying out the processes of the flowcharts in the embodiments can be provided, or such programs may be recorded in a recording medium such as a CD-ROM, a flexible disc, a hard disc, a ROM, a RAM or a memory card so as to be provided to a user. In addition, such programs may be downloaded into a device via a communication line such as the internet.

In addition, though MFPs are illustrated as data output devices in the embodiments, a data output device of the present invention may be a device other than an MFP. A data output device can be formed of, for example, a scanner or a printer having a network function.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image data output device comprising:
a first data information acquirer for acquiring information concerning image data that has been inputted;
a plurality of first memory regions for storing image data;
a data memory controller for storing said image data in a corresponding memory region from among said plurality of first memory regions on the basis of information that has been acquired by said first data information acquirer;
a second data information acquirer for acquiring information concerning image data that has been stored in said first memory regions by said data memory controller;
a managing part for managing the order of output of data that has been set for each of said first memory regions;
a second memory region for storing image data that has been stored in said first memory regions in the order of the output managed by said managing part on the basis of information that has been acquired by said second data information acquirer; and
an outputting part for outputting image data in accordance with the order stored in said second memory region.

2. The image data output device according to claim 1, further comprising:
an adder for adding information to said inputted image data.

3. The image data output device according to claim 1, wherein
in the case where more than one first memory region exists where said image data is to be stored by said data memory controller, said image data is copied so as to be stored in each of the corresponding first memory regions.

4. The image data output device according to claim 1, wherein
more than one second memory region which is the same as said second memory region exists.

5. The image data output device according to claim 1, further comprising:
an eraser for erasing image data that has been stored in said second memory region and that has been outputted when the image data is outputted by said outputting part.

6. The image data output device according to claim 5, wherein
said eraser further erases image data that has been stored in a first memory region and that has been outputted.

7. The image data output device according to claim 1, further comprising:
an outputted data memory region for storing image data that has been outputted; and
a shifter for shifting image data that has been stored in said second memory region and that has been outputted to said outputted data memory region when the image data is outputted by said outputting part.

8. The image data output device according to claim 1, wherein
image data is stored in said second memory region when the image data is outputted by said outputting part.

9. The image data output device according to claim 1, further comprising:
an output time managing part for managing time when image data is outputted by said outputting part, wherein
image data is outputted at a predetermined time.

10. The image data output device according to claim 1, further comprising:
a selector for allowing a user to select one of said first memory regions or said second memory region from which data is to be outputted by said outputting part.

11. An image data output device comprising:
a first data information acquirer for acquiring information concerning image data that has been inputted;
a plurality of first memory regions for storing image data;
a data memory controller for storing said image data in a corresponding memory region from among said plurality of first memory regions on the basis of information that has been acquired by said first data information acquirer;
a second data information acquirer for acquiring information concerning image data that has been stored in said first memory regions by said data memory controller;
a managing part for managing the order of output of data that has been set for each of said first memory regions;
a second memory region for storing image data identification information which identifies image data in the order of the output managed by said managing part on the basis of information that has been acquired by said second data information acquirer; and
an outputting part for outputting image data in accordance with the order stored in said second memory region.

12. An image data output method comprising:
a first data information acquiring step of acquiring information concerning image data that has been inputted;
a data memory controlling step of storing said image data in a corresponding memory region from among a plurality of first memory regions for storing image data on the basis of information that has been acquired in said first data information acquiring step;
a second data information acquiring step of acquiring information concerning the image data that has been stored in said first memory regions in said data memory control step;
a management step of managing the order of the output of the data that has been set for each of said first memory regions;
a memory step of storing the image data that has been stored in said first memory regions in a second memory region in the order of the output managed in said management step on the basis of information acquired in said second data information acquiring step; and
an output step of outputting the image data in accordance with the order stored in said second memory region.

13. An image data outputting program product for allowing a computer to carry out:
a first data information acquiring step of acquiring information concerning image data that has been inputted;
a data memory controlling step of storing said image data in a corresponding memory region from among a plurality of first memory regions for storing image data on the basis of information that has been acquired in said first data information acquiring step;
a second data information acquiring step of acquiring information concerning the image data that has been stored in said first memory regions in said data memory control step;
a management step of managing the order of the output of the data that has been set for each of said first memory regions;
a memory step of storing the image data that has been stored in said first memory regions in a second memory region in the order of the output managed in said management step on the basis of information acquired in said second data information acquiring step; and
an output step of outputting the image data in accordance with the order stored in said second memory region.

14. A computer-readable recording medium, wherein
the program product according to claim 13 is recorded.
